(19) United States
(12) Patent Application Publication
(10) Pub. No.: US 2023/0008613 A1
(43) Pub. Date: Jan. 12, 2023

(54) SPEECH SEPARATION AND RECOGNITION METHOD FOR CALL CENTERS

(71) Applicant: VIETTEL GROUP, Ha Noi City (VN)

(72) Inventors: Van Hai Do, Ha Noi City (VN); Nhat Minh Le, Ha Noi City (VN); Tung Lam Nguyen, Ha Noi City (VN); Quang Trung Le, Vinh Tuong Distric (VN); Tien Thanh Nguyen, Tien Du Distric (VN); Dang Linh Le, Ha Noi City (VN); Dinh Son Dang, Ha Noi City (VN); Thi Ngoc Anh Nguyen, Vinh City (VN); Minh Khang Pham, Ha Noi City (VN); Ngoc Dung Nguyen, Ha Noi City (VN); Manh Quan Tran, Ha Noi City (VN); Manh Quy Nguyen, Ha Noi City (VN)

(73) Assignee: VIETTEL GROUP, Ha Noi City (VN)

(21) Appl. No.: 17/810,267

(22) Filed: Jun. 30, 2022

(30) Foreign Application Priority Data
Jul. 9, 2021 (VN) 1-2021-04220

(51) Int. Cl. G10L 21/0272; G10L 15/04; G10L 15/26

(52) U.S. Cl. CPC G10L 21/0272; G10L 15/04; G10L 15/26

(57) ABSTRACT

The present invention provides a method for speech separation and recognition. The present invention overcomes the disadvantages of the existing techniques by providing automatic speech recognition and separation that helps managers see what their service agents and customers are saying. From there, quickly and objectively knowing the wishes and concerns of customers as well as whether their service agents can give accurate and correct advice. In addition, the system is constantly updated based on the semi-supervised training mechanism, which means that the system can self-learn from actual data during operation, thereby helping to improve the system's accuracy.

### BACKGROUND

### 1. Technical field

The invention relates to a method of speech separation and recognition. Specifically, the present invention relates to a method of speech separation and recognition of service agents, customers, and semi-supervised training in a call center, which enhances the automatic monitoring of customer service call centers.

### 2. Introduction

Today, the number of customer service telephone calls is increasing rapidly in many fields such as telecommunications, finance, electricity, retail, etc. Therefore, knowing the concerns of customers as well as whether service agents are giving accurate and proper advice to customers is an urgent need for managers. This can be done manually using some supervisors who randomly listen to several telephone calls. However, this method is costly in terms of manpower and delays in time, while the information obtained depends on the subjectivity of the supervisors. Therefore, it is necessary to have a method to automatically separate and recognize the speech of the service agents and the customers in customer service telephone calls. In addition, there needs to be an automatic training method to help the system recognize more and more accurately when put into use.

### BRIEF DESCRIPTION OF THE DRAWINGS

FIG. 1 illustrates the training process to build two language models which store language features spoken by service agents and customers (from step 1 to step 4).

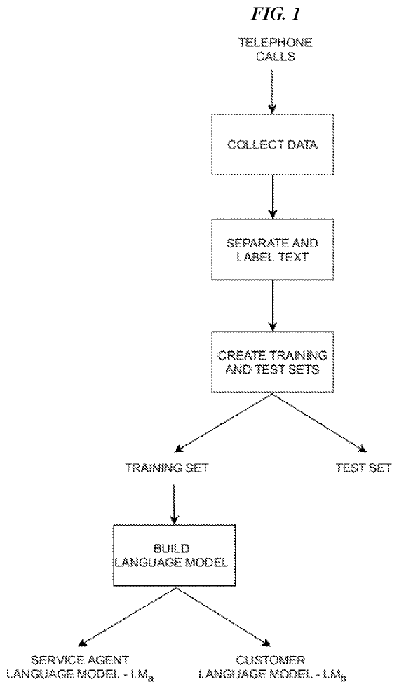

FIG. 2 illustrates the process to automatically separate and recognition speech of service agents and customers in customer service telephone calls (from step 5 to step 11).

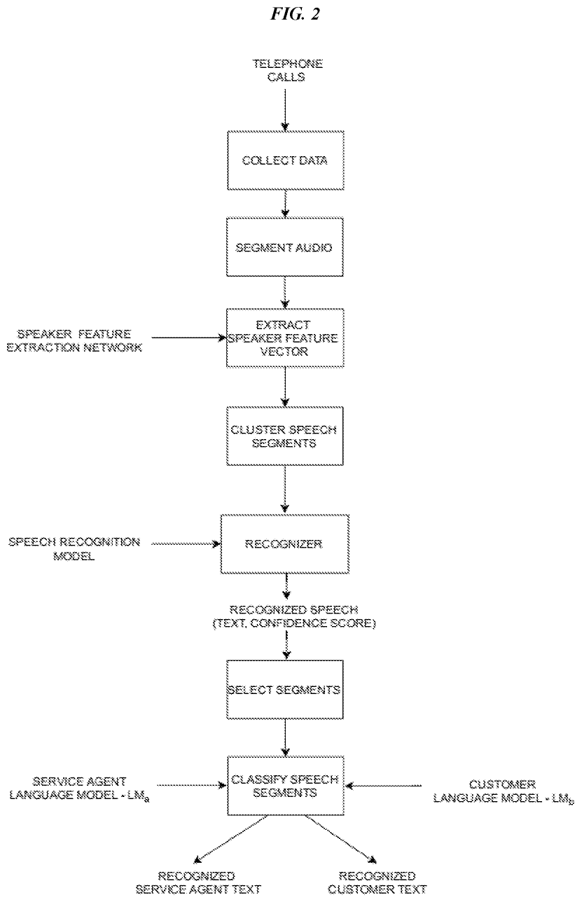

FIG. 3 illustrates the process to improve the two language models using semi-supervised training mechanism (from step 12 to step 15).

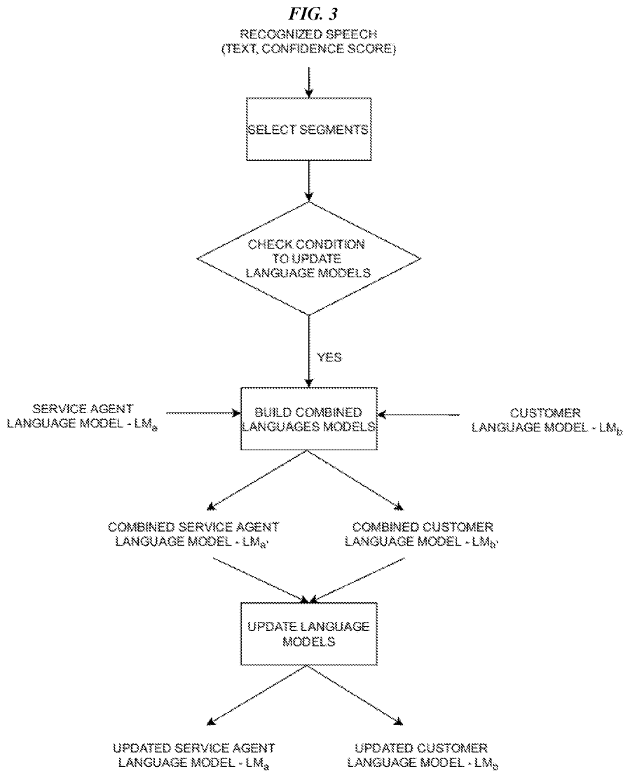

### DETAILED DESCRIPTION

This present invention aims to provide a method for speech separation and recognition of agent, customer, and semi-supervised training in telephone call centers to automate the monitoring of customer service telephone calls.

Specifically, the present invention provides a method including:

Step 1: collect speech data of customer service telephone calls for analysis. This step is done by different methods such as retrieving audio files directly from storage devices such as hard drives, magnetic tapes, etc. or through data network connections, each file corresponds to one customer service telephone call; speech files can be obtained directly on the user's storage device or using file transfer protocols such as FTP to obtain the speech signals;

Step 2: separate and label text for speech files; at this step, put the files in step 1 to the labeling system for the transcribers to listen, separate and label the transcription for the service agent and customer's speech; the output of this step is the speech sets that have been classified and labeled separately into the service agent's speech set and the customer's speech set;

Step 3: create training and test sets; accordingly, when the speech data is labeled in the service agent's speech set and the customer's speech set in step 2, both ≥H_{label_min} data hours, in which H_{label_min}≥10 hours to ensure the data set is large enough; The administrator decides to select some of the speech files labeled in step 2 to create the training set, the remaining files are used to create the test set with the requirement that the test set size needs to be larger than H_{test_min} data hours, where H_{test_min}≥2 hours to ensure that the test set is large enough and reliable;

Step 4: build two language models; LMₐ for agents and LM_{b} for customers based on the training data set created in step 3 to store spoken language features such as frequently spoken phrases by the service agent and the customer from that to distinguish the statements of the service agent or the customer in the following steps; Language models can be n-grams or neural network-based models;

Step 5: collect speech data of telephone calls that need processing for automatic speech separation and recognition; This step is done by different methods such as retrieving audio files directly from storage devices such as hard drives, magnetic tapes, etc. or through data network connections, each file corresponds to one customer service telephone call; speech files can be obtained directly on the user's storage device or using file transfer protocols such as FTP to obtain the speech signals;

Step 6: automatically cut speech files into small segments; for each speech file obtained in step 5, the speech is automatically cut into segments based on the signal characteristics; we can rely on popular methods such as: based on the average energy of the signal or we can rely on speech recognition systems;

Step 7: extract speaker feature vectors; all speech segments obtained in step 6 are extracted by a pre-trained feature extraction network such as a deep learning neural network (DNN) to obtain speaker feature vectors, wherein each speech segment will obtain a corresponding speaker feature vector;

Step 8: cluster speech segments; for each speech file, cluster the speech segments in step 6 into two clusters C₁ and C₂ based on the speaker feature vectors extracted in step 7;

Step 9: convert speech to text; all speech segments in step 6 are converted to text using a speech recognition system, with each speech segment obtaining a corresponding text and a recognition confidence score CS ranging from 0 to 1;

Step 10: select the speech segment satisfying the conditions as a basis for classification; for each speech file, select the speech segments in step 9 that satisfy the condition: have confidence score CS≥α, where 0.5≤α≤0.95 to eliminate speech segments with too low confidence, which are often speech segments with too poor quality or too noisy environment affecting the quality of the classification system; if no satisfactory speech segment is selected, skip the current file and move to a new speech file;

$$w = \frac{{PPL}_{a 1} * {PPL}_{b 2}}{{PPL}_{a 2} * {PPL}_{b 1}}$$

Step 11: classify speech segments of service agents and customers;

$$w = \frac{{PPL}_{a 1} * {PPL}_{b 2}}{{PPL}_{a 2} * {PPL}_{b 1}}$$

with the speech segments selected in step 10 divided into two clusters in step 8, compute, where PPLₐ₁, PPLₐ₂, PPL_{b1}, PPL_{b2} are the perplexity given by the language models LMₐ, LM_{b} in step 4 computed with the text data set of speech segments selected in step 10; PPLₐ₁, PPL_{b1} are computed for the segments in cluster C₁; PPLₐ₂, PPL_{b2} correspond to segments in cluster C₂; if w≤θ, all speech segments in cluster C₁ are identified as service agents, all speech segments in cluster C₂ are identified as customers, and vice versa if w>θ, all speech segments in cluster C₂ are identified as customers speech segments in cluster C₂ are identified as service agents, all speech segments in cluster C₁ are identified as customers; threshold θ has a value in the range from 0.5 to 2.0; After this step, we have completed speech separation and recognition for the service agent and the customer, if there is a need for semi-supervised training to improve the quality of the system, proceed to step 12, otherwise, stop;

Step 12: select speech segments satisfying the conditions to be included in the semi-supervised training set; select speech segments in step 9 meeting the requirement: have confidence score CS>β, in which 0.8≤β≤0.99 to select speech segments with a high recognition confidence score for the semi-supervised training dataset; each speech segment has been labeled as service agent or customer from step 11;

Step 13: choose the time to update the language models; when the training data in the semi-supervised set is greater than a threshold H_{semi_min} data hours and when there is a decision of the administrator, where H_{semi_min}≥10 hours for then semi-supervised training data is large enough and reliable;

Step 14: build language models based on semi-supervised data; at this step, use the data in the semi-supervised set to build two language models, LM_{a_semi} with service agent data and LM_{b_semi} with customer data; then combine with two language models LMₐ, LM_{b} in step 4 to create two language models LM_{a′}, LM_{b′}, with association coefficient k, where 0.8≥k≥0.1;

Step 15: update the language models; compute

$${w}_{0} = \frac{{PPL}_{a 1} * {PPL}_{b 2}}{{PPL}_{a 2} * {PPL}_{b 1}} ,$$

where PPLₐ₁, PPLₐ₂, PPL_{b1}, PPL_{b2} are the perplexity given by the language models LMₐ, LM_{b} in step 4 computed with the text data of the test sets in step 3; PPLₐ₁, PPL_{b1} are computed for the test set consisting of speech segments of the service agent; PPLₐ₂, PPL_{b2} are calculated for the test set of customer speech segments; then compute

$${w}_{1} = \frac{{PPL}_{{a}^{′} 1} * {PPL}_{{b}^{′} 2}}{{PPL}_{{a}^{′} 2} * {PPL}_{{b}^{′} 1}}$$

similar as w₀ by replacing the two language models in step 4 by LM_{a′} and LM_{b′} in step 14; if w₀>q*w₁, update LMₐ with LM_{a′}, LM_{b} with LM_{b′}; where q≥1.0.

### Detailed Description of the Invention

The invention is detailed below, specifically, a method of speech separation and recognition of service agents, customers and semi-supervised training in a customer service call centers comprising of steps:

Step 1: collect speech data of customer service telephone calls for analysis;

Step 2: separate and label text for speech files;

Step 3: create training and test sets;

Step 4: build two language models;

Step 5: collect speech data of telephone calls that need processing for automatic speech separation and recognition;

Step 6: automatically cut speech files into small segments;

Step 7: extract speaker feature vectors;

Step 8: cluster speech segments;

Step 9: convert speech to text;

Step 10: select the speech segments satisfying the conditions as a basis for classification;

Step 11: classify speech segments of service agents and customers;

Step 12: select speech segments satisfying the conditions to be included in the semi-supervised training set;

Step 13: choose the time to update the language models;

Step 14: build language models based on semi-supervised data;

Step 15: update the language models.

The details of these steps are as follows:

Step 1: collect speech data of customer service telephone calls for analysis. This step is done by different methods such as retrieving audio files directly from storage devices such as hard drives, magnetic tapes, etc. or through data network connections, each file corresponds to one customer service telephone call; speech files can be obtained directly on the user's storage device or using file transfer protocols such as FTP to obtain the speech signals.

Step 2: separate and label text for speech files; at this step, put the files in step 1 to the labeling system for the transcribers to listen, separate and label the transcription for the service agent and customer's speech; the output of this step is the speech sets that have been classified and labeled separately into the service agent's speech set and the customer's speech set.

Step 3: create training and test sets; accordingly, when the speech data is labeled in the service agent's speech set and the customer's speech set in step 2, both≥H_{label_min} data hours, in which H_{label_min}≥10 hours to ensure the data set is large enough; The administrator decides to select some of the speech files labeled in step 2 to create the training set, the remaining files are used to create the test set with the requirement that the test set size needs to be larger than H_{test_min} data hours, where H_{test_min}≥2 hours to ensure that the test set is large enough and reliable.

Step 4: build two language models; LMₐ for agents and LM_{b} for customers based on the training data set created in step 3 to store spoken language features such as frequently spoken phrases by the service agent and the customer from that to distinguish the statements of the service agent or the customer in the following steps; Language models can be n-grams or neural network-based models.

Step 5: collect speech data of telephone calls that need processing for automatic speech separation and recognition; This step is done by different methods such as retrieving audio files directly from storage devices such as hard drives, magnetic tapes, etc. or through data network connections, each file corresponds to one customer service telephone call; speech files can be obtained directly on the user's storage device or using file transfer protocols such as FTP to obtain the speech signals.

Step 6: automatically cut speech files into small segments; for each speech file obtained in step 5, the speech is automatically cut into segments based on the signal characteristics; we can rely on popular methods such as: based on the average energy of the signal or we can rely on speech recognition systems.

Step 7: extract speaker feature vectors; all speech segments obtained in step 6 are extracted by a pre-trained feature extraction network such as deep learning neural network (DNN) to obtain speaker feature vectors, with each speech segment will obtain a corresponding speaker feature vector.

Step 8: cluster speech segments; for each speech file, cluster the speech segments in step 6 into two clusters C₁ and C₂ based on the speaker feature vectors extracted in step 7.

Step 9: convert speech to text; all speech segments in step 6 are converted to text using a speech recognition system, with each speech segment obtaining a corresponding text and a recognition confidence score CS ranging from 0 to 1.

Step 10: select the speech segment satisfying the conditions as a basis for classification; for each speech file, select the speech segments in step 9 that satisfy the condition: have confidence score CS≥α, where 0.5≤α≤0.95 to eliminate speech segments with too low confidence, which are often speech segments with too poor quality or too noisy environment affecting the quality of the classification system; if no satisfactory speech segment is selected, skip the current file and move to a new speech file.

$$w = \frac{{PPL}_{a 1} * {PPL}_{b 2}}{{PPL}_{a 2} * {PPL}_{b 1}}$$

Step 11: classify speech segments of service agents and customers;

$$w = \frac{{PPL}_{a 1} * {PPL}_{b 2}}{{PPL}_{a 2} * {PPL}_{b 1}}$$

with the speech segments selected in step 10 divided into two clusters in step 8, compute, where PPLₐ₁, PPLₐ₂, PPL_{b1}, PPL_{b2} are the perplexity given by the language models LMₐ, LM_{b} in step 4 computed with the text data set of speech segments selected in step 10; PPLₐ₁, PPL_{b1} are computed for the segments in cluster C₁; PPLₐ₂, PPL_{b2} correspond to segments in cluster C₂; if w≤θ, all speech segments in cluster C₁ are identified as service agents, all speech segments in cluster C₂ are identified as customers, and vice versa if w>θ, all speech segments in cluster C₂ are identified as customers speech segments in cluster C₂ are identified as service agents, all speech segments in cluster C₁ are identified as customers; threshold θ has a value in the range from 0.5 to 2.0; After this step, we have completed speech separation and recognition for the service agent and the customer, if there is a need for semi-supervised training to improve the quality of the system, proceed to step 12, otherwise, stop.

Step 12: select speech segments satisfying the conditions to be included in the semi-supervised training set; select speech segments in step 9 meeting the requirement: of having confidence score CS≥β, in which 0.8≤β≤0.99 to select speech segments with a high recognition confidence score for the semi-supervised training dataset; each speech segment has been labeled as service agent or customer from step 11.

Step 13: choose the time to update the language models; when the training data in the semi-supervised set is greater than a threshold H_{semi_min} data hours and when there is a decision of the administrator, where H_{semi_min}>10 hours for then semi-supervised training data is large enough and reliable.

Step 14: build language models based on semi-supervised data; at this step, use the data in the semi-supervised set to build two language models, LM_{a_semi} with service agent data and LM_{b_semi} with customer data; then combine with two language models LMₐ, LM_{b} in step 4 to create two language models LM_{a′}, LM_{b′} with association coefficient k, where 0.8≥k≥0.1.

Step 15: update the language models; compute

$${w}_{0} = \frac{{PPL}_{a 1} * {PPL}_{b 2}}{{PPL}_{a 2} * {PPL}_{b 1}} ,$$

where PPLₐ₁, PPLₐ₂, PPL_{b1}, PPL_{b2} are the perplexity given by the language models LMₐ, LM_{b} in step 4 computed with the text data of the test sets in step 3; PPLₐ₁, PPL_{b1} are computed for the test set consisting of speech segments of the service agent; PPLₐ₂, PPL_{b2} are calculated for the test set of customer speech segments; then compute

$${w}_{1} = \frac{{PPL}_{{a}^{′} 1} * {PPL}_{{b}^{′} 2}}{{PPL}_{{a}^{′} 2} * {PPL}_{{b}^{′} 1}}$$

similar as w₀ by replacing the two language models in step 4 by LM_{a′} and LM_{b′} in step 14; if w₀>q*w₁, update LMₐ with LM_{a′}, LM_{b} with LM_{b′}; where q≥1.0.

### Examples of Invention

The solution has been applied to build a method of separating, recognizing the speech of service agents, customers and semi-supervised training in Viettel's customer service call centers.

At Viettel customer service call centers, we use this method to separate and recognize the speech of service agents and customers into text. From there, it is possible to monitor and make statistics for the content of customer service telephone calls automatically and quickly. In addition, we can also know the thoughts and frustrations of the customers as well as whether the service agent's response is correct. The system is constantly updated based on the semi-supervised training mechanism, thereby helping to improve the accuracy of the system.

### Effect of Invention

A special advantage related to this present invention is to develop a method of speech separation and recognition of service agents, customers and semi-supervised training in call centers. This recommendation method lets managers see what their service agents and customers say. From there, quickly and objectively know the wishes and concerns of customers as well as whether their service agents can give accurate and correct advice. In addition, the system is constantly updated based on the semi-supervised training mechanism, which means that the system can self-learn from actual data during operation, thereby helping to improve the system's accuracy.

Although the above descriptions contain many specifics, they are not intended to be a limitation of the embodiment of the invention but are intended only to illustrate some preferred execution.

1. A speech separation and recognition method, comprising:
step 1: collect speech data of customer service telephone calls for analysis by retrieving audio files, each file corresponds to one customer service telephone call;
step 2: separate and label text for speech files; at this step, the audio files retrieved in step 1 are provided to a labeling system for transcribers to listen, separate and label a transcription for a service agent's and a customer's speech; the output of this step is speech sets that have been classified and labeled separately into service agent's speech set files and customer's speech set files;
step 3: create training and test sets; when the speech sets are labeled in the service agent's speech set and the customer's speech set in step 2, both≥H_{label_min} data hours, in which H_{label_min}≥10 hours to ensure a data set is large enough; an administrator decides to select some of the speech set files labeled in step 2 to create a training set, the remaining files are used to create a test set with the requirement that a test set size needs to be larger than H_{test_min.} data hours, where H_{test_min}≥2 hours to ensure that the test set is large enough and reliable;
step 4: build two language models; a first language model LMₐ for agents and a second language model LM_{b} for customers based on the training data sets created in step 3 to store spoken language features including frequently spoken phrases by the service agents and the customers in order to distinguish the statements of the service agents or the customers in following steps; wherein the language models can be used as n-grams or neural network-based models;
step 5: collect speech data files of telephone calls that need processing for automatic speech separation and recognition; each file corresponds to one customer service telephone call;
step 6: automatically cut speech files into small segments; for each speech file obtained in step 5, the speech is automatically cut into segments based on signal characteristics;
step 7: extract speaker feature vectors; all speech segments obtained in step 6 are extracted by a pre-trained feature extraction network to obtain speaker feature vectors, with each speech segment will obtain a corresponding speaker feature vector;
step 8: cluster speech segments; for each speech file, cluster the speech segments in step 6 into two clusters C₁ and C₂ based on the speaker feature vectors extracted in step 7;
step 9: convert speech to text; converting all speech segments in step 6 to text using a speech recognition system, with each speech segment obtaining a corresponding text and a recognition confidence score CS with a value ranging from 0 to 1;
step 10: select the speech segment satisfying the conditions as a basis for classification; for each speech file, select the speech segments in step 9 that satisfy the condition: having confidence score CS>α, where 0.5≤α≤0.95 to eliminate speech segments with too low confidence; if no satisfactory speech segment is selected, skip the current file and move to a new speech file;
$$w = \frac{{PPL}_{a 1} * {PPL}_{b 2}}{{PPL}_{a 2} * {PPL}_{b 1}}$$
step 11: classify speech segments of service agents and customers;
$$w = \frac{{PPL}_{a 1} * {PPL}_{b 2}}{{PPL}_{a 2} * {PPL}_{b 1}}$$
with the speech segments selected in step 10 divided into two clusters in step 8, compute, where PPLₐ₁, PPLₐ₂, PPL_{b1}, PPL_{b2} are a perplexity given by the language models LMₐ, LM_{b} in step 4 computed with the text data set of speech segments selected in step 10; PPLₐ₁, PPL_{b1} are computed for the segments in cluster C₁; PPLₐ₂, PPL_{b2} correspond to segments in cluster C₂; if w≤θ, all speech segments in cluster C₁ are identified as service agents, all speech segments in cluster C₂ are identified as customers, and vice versa if w>θ, all speech segments in cluster C₂ are identified as customers speech segments in cluster C₂ are identified as service agents, all speech segments in cluster C₁ are identified as customers; a threshold θ has a value in the range from 0.5 to 2.0; after this step, we have done speech separation and recognition for the service agent and the customer, if there is a need for semi-supervised training to improve the quality of the system, proceed to step 12, otherwise, stop;
step 12: select speech segments satisfying conditions to be included in the semi-supervised training set; select speech segments in step 9 meeting the requirement: have confidence score CS≥β, in which 0.8≤β≤0.99 to select speech segments with a high recognition confidence score for the semi-supervised training dataset; each speech segment has been labeled as service agent or customer from step 11;
step 13: choose a time to update the language models; when the training data in the semi-supervised set is greater than a threshold H_{semi_min} data hours and when there is a decision of the administrator, where H_{semi_min}≥10 hours for then semi-supervised training data is large enough and reliable;
step 14: build language models based on semi-supervised data; at this step, use the data in the semi-supervised set to build two language models, LM_{a_semi} with service agent data and LM_{b_semi} with customer data; then combine with two language models LMₐ, LM_{b} in step 4 to create two language models LM_{a′}, LM_{b′} with an association coefficient k, where 0.8≥k≥0.1;
step 15: update the language models; compute
$${w}_{0} = \frac{{PPL}_{a 1} * {PPL}_{b 2}}{{PPL}_{a 2} * {PPL}_{b 1}} ,$$
where PPLₐ₁, PPLₐ₂, PPL_{b1}, PPL_{b2} are the perplexity given by the language models LMₐ, LM_{b} in step 4 computed with the text data of the test sets in step 3; PPLₐ₁, PPL_{b1} are computed for the test set consisting of speech segments of the service agent; PPLₐ₂, PPL_{b2} are calculated for the test set of customer speech segments; then compute
$${w}_{1} = \frac{{PPL}_{{a}^{′} 1} * {PPL}_{{b}^{′} 2}}{{PPL}_{{a}^{′} 2} * {PPL}_{{b}^{′} 1}}$$
as w₀ by replacing the two language models in step 4 by LM_{a′} and LM_{b′} in step 14; if w₀>q*w₁, update LMₐ with LM_{a′}, LM_{b} with LM_{b′}; where q≥1.0.

2. The method according to claim 1, wherein in step 7, the pre-trained feature extraction network comprises a deep learning neural network (DNN).

3. The method according to claim 1, where the audio files are retrieved directly from storage devices comprising hard drives.

4. The method according to claim 1, where the audio files are retrieved directly from storage devices comprising magnetic tapes.

5. The method according to claim 1, where the audio files are retrieved through data network connections.

6. The method according to claim 1, where the audio files are obtained directly on a user's storage device.

7. The method according to claim 1, where the audio files are obtained using file transfer protocols such as FTP to obtain the speech signals.
